(19) United States
(12) Patent Application Publication
(10) Pub. No.: US 2019/0187972 A1
(43) Pub. Date: Jun. 20, 2019

(54) CLIENT TERMINAL, INFORMATION PROCESSING SYSTEM, AND FIRMWARE UPDATE NOTIFICATION METHOD

(71) Applicant: Mitsuhiko HIROSE, Kanagawa (JP)

(72) Inventor: Mitsuhiko HIROSE, Kanagawa (JP)

(21) Appl. No.: 16/182,649

(22) Filed: Nov. 7, 2018

(30) Foreign Application Priority Data
Dec. 19, 2017 (JP) 2017-243162
Sep. 5, 2018 (JP) 2018-166362

(51) Int. Cl. G06F 8/65; H04L 29/08; H04L 12/24

(52) U.S. Cl. CPC G06F 8/65; H04L 41/082; H04L 67/34

(57) ABSTRACT

A client terminal, an information processing system and a firmware update notification method. The information processing system includes the client terminal, an electronic device, and a server that provides the firmware for the electronic device. The firmware update notification method includes acquiring version information of the firmware installed on the electronic device and the latest firmware available on the server, comparing the version of the firmware installed on the electronic device with the version of the latest firmware available on the server, determining whether the latest firmware to update the firmware installed on the electronic device is available on the server, providing notice that the latest firmware to update the firmware installed on the electronic device is available on the server and acquiring the latest firmware from the server to update the firmware installed on the electronic device based on an inputted instruction.

### CROSS-REFERENCE TO RELATED APPLICATIONS

This patent application is based on and claims priority pursuant to 35 U.S.C. § 119(a) to Japanese Patent Application Nos. 2017-243162 and 2018-166362, filed on Dec. 19, 2017 and Sep. 5, 2018, respectively in the Japan Patent Office, the entire disclosure of which are hereby incorporated by reference herein.

### BACKGROUND

### Technical Field

The present disclosure relates to a client terminal, an information processing system and a firmware update notification method.

### Background Art

Conventionally, there are network systems that connect a management server and a network device and update the firmware of the network device. In such a network system, when a new version of the firmware is released, the network system sends a notification of the update to an administrator of the network system.

For example, an electronic device such as a digital camera accepts operation from an application of the client terminal such as a smartphone communicably connected to the electronic device. To update the firmware of the electronic device using the client terminal communicably connected to the electronic device, it is necessary to compare the version information of the published firmware with the version information of the firmware installed on the electronic device.

### SUMMARY

Embodiments of the present disclosure described herein provide an improved client terminal, an information processing system and a firmware update notification method. The information processing system includes the client terminal, an electronic device, and a server that provides the firmware for the electronic device. The firmware update notification method includes acquiring version information of the firmware installed on the electronic device, acquiring version information of the latest firmware available in the server, comparing the version of the firmware installed on the electronic device with the version of the latest firmware available in the server, determining whether the latest firmware to update the firmware installed on the electronic device is available in the server, providing notice that the latest firmware to update the firmware installed on the electronic device is available in the server when the latest firmware to update the firmware installed on the electronic device is identified in the server and when the electronic device is not being used by the client terminal, and acquiring the latest firmware from the server to update the firmware installed on the electronic device based on an inputted instruction.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1A and FIG. 1B are diagrams illustrating an example of a system configuration of an information processing system according to one or more embodiments of the present disclosure;

FIG. 2 is a block diagram illustrating an example of a hardware configuration of a server according to one or more embodiments of the present disclosure;

FIG. 3 is a block diagram illustrating a hardware configuration of a client terminal according to one or more embodiments of the present disclosure;

FIG. 4 is a block diagram illustrating an example of a hardware configuration of an imaging device, according to one or more embodiments of the present disclosure;

FIG. 5 is a block diagram illustrating a functional configuration of the client terminal according to one or more embodiments of the present disclosure;

FIG. 6 is a flowchart illustrating an example of firmware updating by the client terminal to update the firmware installed in the imaging device;

FIG. 7 is a flowchart illustrating first embodiment of firmware updating by the client terminal to update the firmware installed in the imaging device;

FIG. 8 is a conceptual diagram illustrating an example of a firmware update confirmation pop-up;

FIG. 9 is a conceptual diagram illustrating an example of a settings screen for notifying by an icon that the firmware installed in the imaging device can be updated;

FIG. 10 is a flowchart illustrating a second embodiment of firmware updating by the client terminal to update the firmware installed in the imaging device;

FIG. 11 is a conceptual diagram illustrating an example of the update confirmation pop-up displayed when the imaging device is disconnected;

FIG. 12 is a flowchart illustrating a third embodiment of firmware updating by the client terminal to update the firmware installed in the imaging device;

FIG. 13 is a conceptual diagram illustrating an example of a toast pop-up notification that the firmware installed in the imaging device can be updated; and

FIG. 14 is a conceptual diagram illustrating an example of a firmware update screen.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an”, and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, a description is given of several embodiments of the present disclosure.

As described above, in the background art, the client terminal can obtain the version information of the firmware installed on the electronic device at a timing at which the client terminal is connected to the electronic device, for example, and compare the obtained version information of the firmware with the version information of the published firmware.

However, there is a strong possibility that the timing at which the client terminal is communicably connected to the electronic device is the timing when a user is about to operate the electronic device. If firmware update of the electronic device is notified by the client terminal when the user is about to operate the electronic device, there is a strong possibility that the user's operation on the electronic device will be hindered.

System Configuration

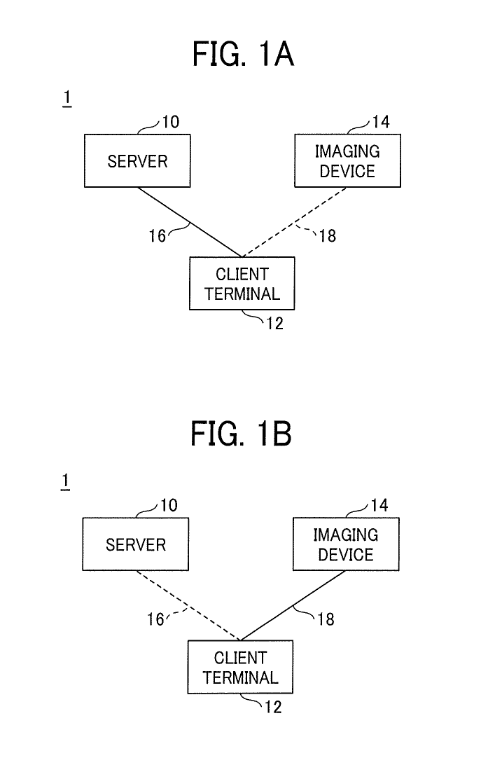

FIG. 1A and FIG. 1B are diagrams illustrating an example of a system configuration of the information processing system according to the present embodiment. As illustrated in FIG. 1A and FIG. 1B, the information processing system 1 according to the present embodiment includes a server 10, a client terminal 12, and an imaging device 14. The server 10 and the client terminal 12 are connected by a network 16 such as mobile data communication network (for example, 3G/LTE etc.) or a wireless local area network (LAN). In addition, the imaging device 14 and the client terminal 12 are connected via a network 18 such as short-range wireless communication network (for example, Bluetooth low energy (BLE) or the like) or a wireless LAN. The client terminal 12 connects to the server 10 or the imaging device 14 by switching the connection destination between the network 16 and the network 18.

In FIG. 1A, the client terminal 12 switches the connection destination to the network 16 and connects to the server 10. In FIG. 1B, the client terminal 12 switches the connection destination to the network 18 and connects to the imaging device 14. For example, in FIG. 1B, a communication method such as Wi-Fi Direct (registered trademark) may be used for the client terminal 12 to communicate directly with the imaging device 14.

Firmware for the imaging device 14 is uploaded onto the server 10, and the server 10 manages the firmware for the imaging device 14. The server 10 provides firmware version information of the firmware to the client terminal 12 in response to a request from the client terminal 12. Further, the server 10 causes the client terminal 12 to download the firmware in response to a request from the client terminal 12. Note that the server 10 of the information processing system 1 of FIG. 1A and FIG. 1B is an example and may be configured by a plurality of computers such that functions or operations are distributed over the plurality of computers.

The client terminal 12 is an example of a mobile terminal such as a smart device, a tablet terminal, a mobile phone, a laptop, and the like to be operated by a user. An application for operating the imaging device 14 is installed on the client terminal 12. The application of the client terminal 12 connects to the imaging device 14 via the network 18 for the user to use the function of the imaging device 14. The application of the client terminal 12 connects to the server 10 via the network 16. The application of the client terminal 12 downloads the firmware from the server 10 and updates the firmware installed in the imaging device 14 with the downloaded firmware.

The application of the client terminal 12 connected to the imaging device 14 displays an image captured by the imaging device 14 and accepts the user's operation on the imaging device 14. As described above, in addition to transferring data of the captured image for display, the imaging device 14 may be connected to the client terminal 12 also when using the imaging device 14 such as capturing the image with the imaging device 14.

The imaging device 14 is an example of the electronic device with the firmware installed. Electronic devices with the firmware installed include various devices such as a digital camera, a digital video camera, a digital measuring device, and the like. The electronic device according to this embodiment includes any electronic device that updates the installed firmware under control of the application of the client terminal 12. The imaging device 14 can send captured image data to the client terminal 12 for display or storage.

Hardware Configuration

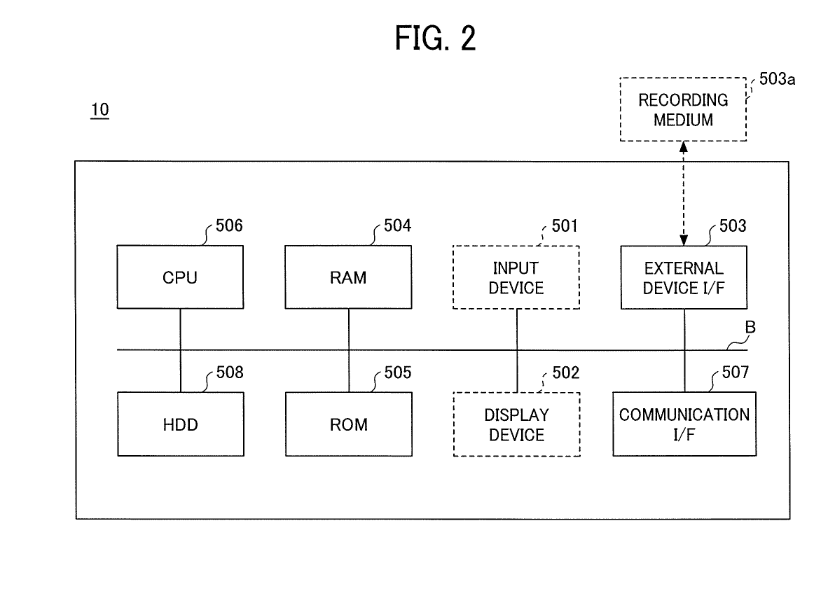

An example of a hardware configuration of the server 10 according to the present embodiment is illustrated in FIG. 2.

As illustrated in FIG. 2, the server 10 includes an input device 501, a display device 502, an external device interface (I/F) 503, a random access memory (RAM) 504, a read only memory (ROM) 505, a central processing unit (CPU) 506, a communication interface (I/F) 507 and a hard disk drive (HDD) 508, and the like, each mutually connected by a bus B. Note that the input device 501 and the display device 502 may be provided externally to the server 10 and connected to the bus B as necessary.

The input device 501 includes a keyboard, a mouse, and a touch panel to enable the user to input various operation signals. The display device 502 includes a display and the like and displays the processing result of the server 10.

The communication I/F 507 is an interface for connecting the server 10 to various networks. The server 10 can perform data communication via the communication I/F 507.

The HDD 508 is an example of a nonvolatile storage device storing programs and data. Examples of the programs or data stored in the HDD 508 include an operating system (OS) for controlling entire operation of the server 10 and programs providing various functions on the OS. The server 10 may use a drive device using a flash memory such as a solid-state drive (SSD) as a storage medium instead of the HDD 508.

The external device I/F 503 is an interface that connects the server 10 to an external device. Example of the external device includes a recording medium 503a. The external device I/F 503 enables the server 10 to read or write data from or to the recording medium 503a. Examples of the recording medium 503a include a flexible disc, a compact disc (CD), a digital versatile disc (DVD), a secure digital (SD) memory card, and a universal serial bus (USB) memory.

The ROM 505 is an example of a nonvolatile semiconductor memory (storage) capable of storing the program and data, such that the program and data are kept even after the server 10 is turned off and the power is not supplied. The ROM 505 stores programs and data such as a basic input/output program, OS settings, and network settings, which are executed at the time of starting the server 10. The RAM 504 is an example of a volatile semiconductor memory (storage) that temporarily stores programs and data.

The CPU 506 loads programs or data from the storage device such as the ROM 505 and the HDD 508 onto the RAM 504 and executes processes to implement entire control of the server 10 or functions of the server 10. The server 10 implements various kinds of processing as will be described later with the hardware configuration as illustrated as an example in FIG. 2.

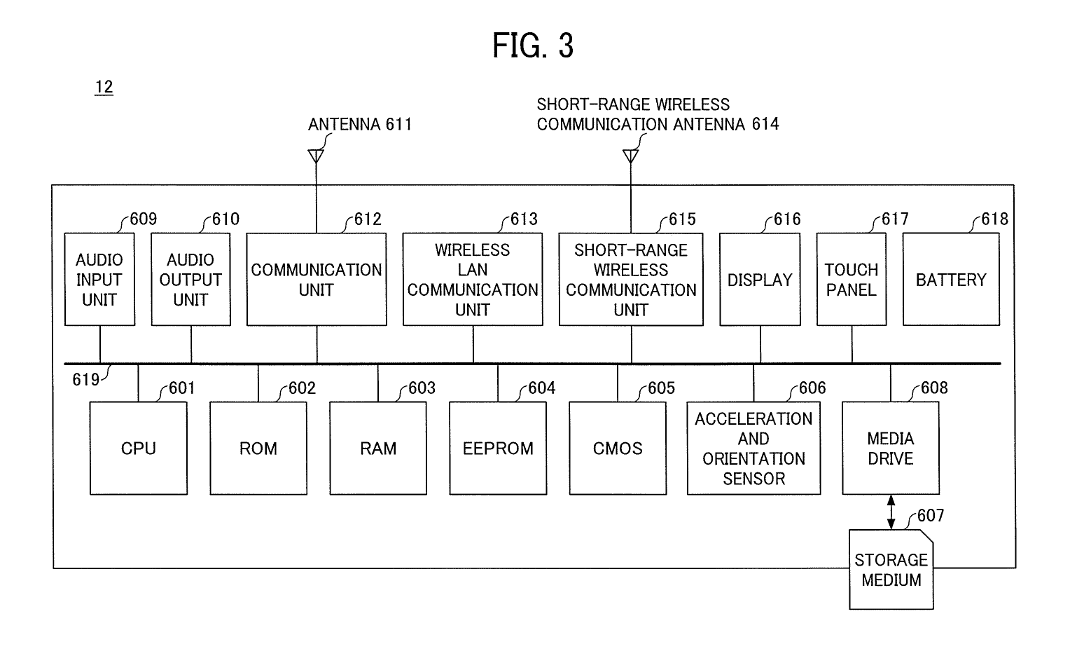

FIG. 3 is an example of a hardware configuration of the client terminal 12 according to the present embodiment. The client terminal 12 in FIG. 3 includes, for example, a CPU 601, a ROM 602, a RAM 603, an electrically erasable programmable read only memory (EEPROM) 604, a complementary metal oxide semiconductor (CMOS) sensor 605, an acceleration and orientation sensor 606 and a media drive 608.

The CPU 601 controls all the operations of the client terminal 12. The ROM 602 stores the basic input/output program. The RAM 603 is used as a work area for the CPU 601. The EEPROM 604 performs reading or writing of data under the control of the CPU 601. The CMOS sensor 605 captures image data under the control of the CPU 601. Example of the acceleration and orientation sensor 606 includes an electromagnetic compass or gyrocompass for detecting geomagnetism and an acceleration sensor.

The media drive 608 controls reading or writing (storing) of data from and to a storage medium 607 such as a flash memory. The storage medium 607 is removably mounted to the media drive 608. Accordingly, under control of the media drive 608, data recorded in the storage medium 607 is read from the storage medium 607 and new data is written (stored) into the storage medium 607.

Note that the EEPROM 604 stores the OS executed by the CPU 601, associated information necessary for the network setting, and the like. The application for executing various processes in the present embodiment is stored in the EEPROM 604, the storage medium 607, or the like.

The CMOS sensor 605 is a charge coupled device (CCD) to convert the image of an object into electronic data through photoelectric conversion. In alternative to the CMOS sensor 605, another CCD may be used, provided that the CCD is capable of capturing the image.

Further, the client terminal 12 includes an audio input unit 609, an audio output unit 610, an antenna 611, a communication unit 612, a wireless LAN communication unit 613, a short-range wireless communication antenna 614, a short-range wireless communication unit 615, a display 616, a touch panel 617, and a bus line 619.

The audio input unit 609 converts sound into an audio signal. The audio output unit 610 converts an audio signal into sound. The communication unit 612 communicates with the nearest base station apparatus by using a wireless communication signal using the antenna 611. The wireless LAN communication unit 613 performs wireless LAN communication conforming to the IEEE802.11 standard or the like. The short-range wireless communication unit 615 performs short-range wireless communication using the short-range wireless communication antenna 614.

The display 616 displays the image of the object, various kinds of icons, and the like. Examples of the display 616 include a liquid crystal display (LCD) or an organic electroluminescence display. The touch panel 617 is disposed on the display 616. Examples of the touch panel 617 include a pressure-sensing panel and an electrostatic panel. The touch panel 617 detects a position on the display 616 touched by a finger, a stylus, and the like. The bus line 619 is an address bus or a data bus, which electrically connects the hardware elements described above.

In addition, the client terminal 12 includes a dedicated battery 618. The client terminal 12 is powered by the battery 618. The audio input unit 609 includes a microphone to collect sound. The audio output unit 610 includes a speaker to output sound. The client terminal 12 implements various processes to be described later with the hardware configuration as illustrated as an example in FIG. 3.

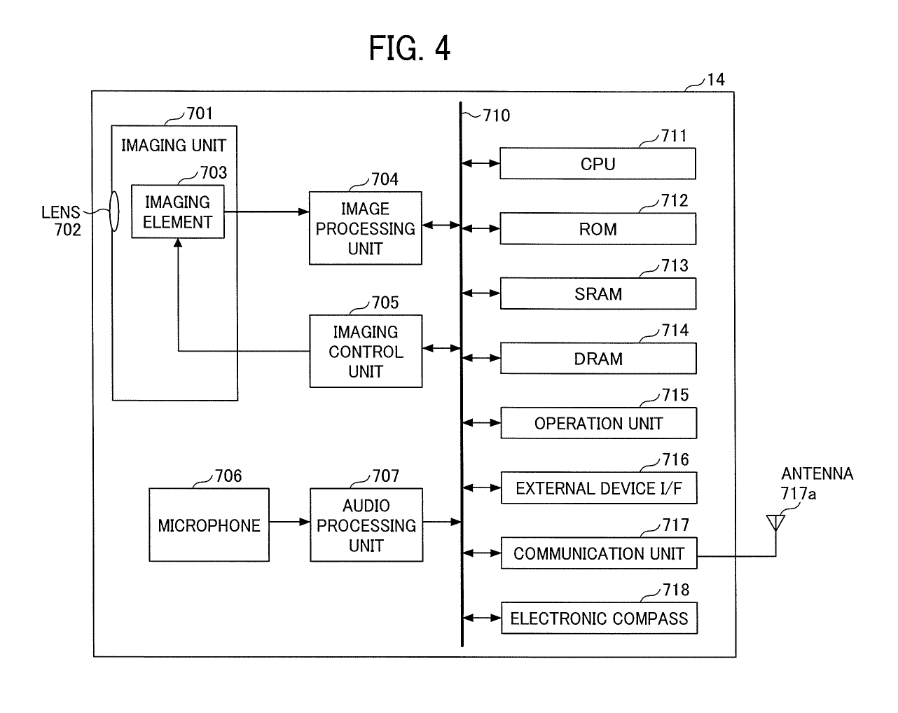

FIG. 4 is an example of a hardware configuration of the imaging device 14 according to the present embodiment. The imaging device 14 includes an imaging unit 701, an image processing unit 704, an imaging control unit 705, a microphone 706, an audio processing unit 707, a CPU 711, a ROM 712, a static random access memory (SRAM) 713, a dynamic random access memory (DRAM) 714, an operation unit 715, an external device I/F 716, a communication unit 717, an antenna 717a, and an electronic compass 718.

The imaging unit 701 includes a lens 702 and an imaging element 703 corresponding to the lens 702. The imaging element 703 has an image sensor such as a CMOS sensor or a CCD sensor to convert an optical image formed by the lens 702 into electrical signal and outputs the image data. The imaging element 703 has a timing generation circuit for generating horizontal or vertical synchronization signals of the image sensor, a pixel clock and the like, a group of registers in which various commands and parameters necessary for operation are set.

The imaging element 703 of the imaging unit 701 is connected to the image processing unit 704 via a parallel I/F bus. The imaging element 703 of the imaging unit 701 is connected to the imaging control unit 705 via a serial I/F bus such as an inter-integrated circuit (I2C) bus or the like. The image processing unit 704 and the imaging control unit 705 are connected to the CPU 711 via a bus 710. The bus 710 is also connected with the ROM 712, the SRAM 713, the DRAM 714, the operation unit 715, the external device I/F 716, the communication unit 717, the electronic compass 718, and the like.

The image processing unit 704 fetches the image data output from the imaging element 703 through the parallel I/F bus and performs processing on each image data. In addition, the imaging control unit 705 sets commands and the like in the register group of the imaging element 703 by using the I2C bus. The imaging control unit 705 receives necessary commands from the CPU 711. Also, the imaging control unit 705 takes in the status data and the like of the register group of the imaging element 703 using the I2C bus and sends the data to the CPU 711.

Further, the imaging control unit 705 instructs the imaging element 703 to output image data when the shutter button of the operation unit 715 is pressed. The microphone 706 converts sound to audio data (signal). The audio processing unit 707 acquires audio data output from the microphone 706 via an I/F bus and performs processing on the audio data.

The CPU 711 controls the overall operation of the imaging device 14. The ROM 712 stores various programs for the CPU 711. The SRAM 713 and the DRAM 714 are work memories to store programs to be executed by the CPU 711, data being processed, and the like. In particular, the DRAM 714 stores image data being processed in the image processing unit 704 and data of processed images.

The operation unit 715 includes various operation keys, a power switch, the shutter button, and the touch panel having functions of both displaying information and receiving input from the user. The user inputs various imaging modes and imaging conditions by operating the operation keys.

The external device I/F 716 collectively refers to interface circuits such as universal serial bus (USB) I/F with external media such as SD cards and external devices such as personal computers (PCs). The communication unit 717 communicates by wireless LAN or short-range wireless technology via an antenna 717a provided in the imaging device 14. The electronic compass 718 calculates the orientation and tilt of the imaging device 14 from the earth's magnetic field and outputs orientation and tilt information.

Functional Configuration

Hereinafter, the functional configuration of the client terminal 12 is described. The functional configurations of the server 10 and the imaging device 14 are the same as those of the existing functional configuration, so the description thereof is omitted.

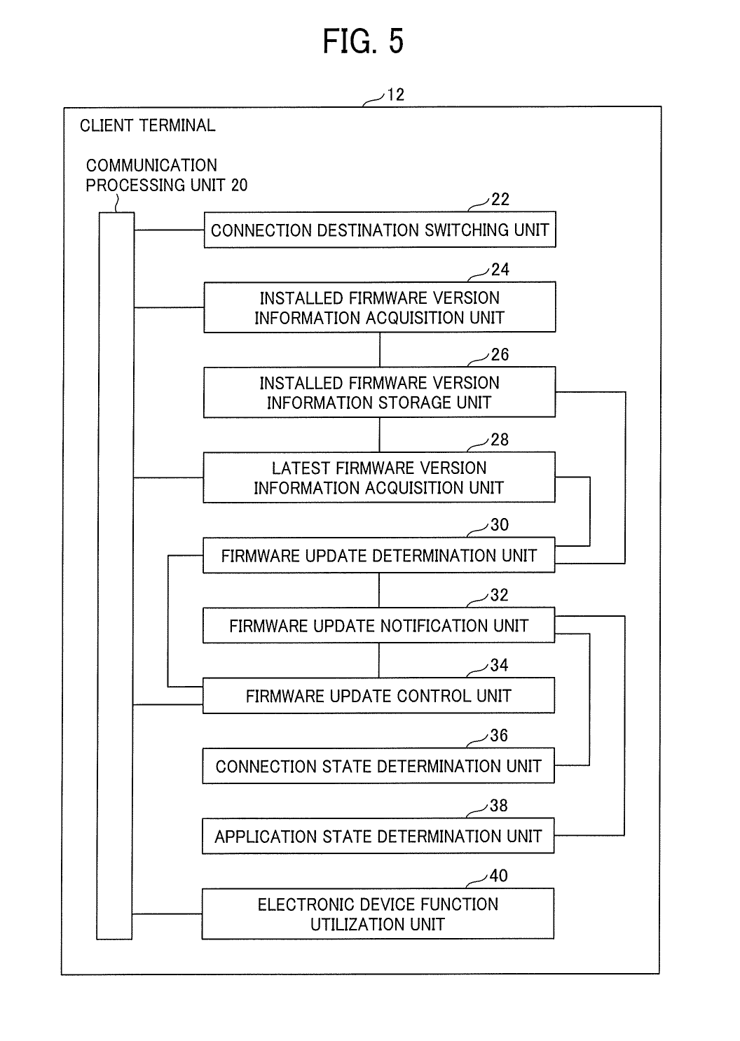

FIG. 5 is a block diagram illustrating the functional configuration of the client terminal 12 according to an embodiment of the present disclosure. By executing a program such as the application for the imaging device 14, the client terminal 12 implements a communication processing unit 20, a connection destination switching unit 22, an installed firmware version information acquisition unit 24, an installed firmware version information storage unit 26, a latest firmware version information acquisition unit 28, a firmware update determination unit 30, a firmware update notification unit 32, a firmware update control unit 34, a connection state determination unit 36, an application state determination unit 38, and an electronic device function utilization unit 40.

The communication processing unit 20 communicates with the server 10 or the imaging device 14 via the connection destination network 16 or 18. The connection destination switching unit 22 switches the connection destination to the network 16 or to the network 18 by the user operation.

When the installed firmware version information acquisition unit 24 is connected to the imaging device 14, the installed firmware version information acquisition unit 24 acquires the version information of the firmware installed in the imaging device 14 from the imaging device 14. The installed firmware version information acquisition unit 24 causes the installed firmware version information storage unit 26 to store the version information of the installed firmware acquired from the imaging device 14. The installed firmware version information acquisition unit 24 of the client terminal 12 that accesses one or more imaging devices 14 acquires the version information of the installed firmware for a specific imaging device 14 in association with a serial number or the like to uniquely identify the specific imaging device 14 and causes the installed firmware version information storage unit 26 to store the installed firmware version information in association with the serial number or the like.

The latest firmware version information acquisition unit 28 acquires the version information of the latest firmware from the server 10 and notifies the firmware update determination unit 30 of the version information of the latest firmware. In addition, the latest firmware version information acquisition unit 28 stores the acquired version information of the latest firmware in the installed firmware version information storage unit 26. The firmware update determination unit 30 compares the version information of the latest and the installed firmware, and determines whether the installed firmware should be updated to the latest firmware on the server 10.

When the installed firmware should be updated to the latest firmware, the firmware update notification unit 32 notifies the user of firmware update by displaying on the display that the firmware installed in the imaging device 14 can be updated when the application for the imaging device 14 is not using the function of the imaging device 14 as will be described later.

When the user approves the firmware update, the firmware update control unit 34 downloads the latest firmware from the server 10 and updates the firmware installed in the imaging device 14 with the latest firmware.

The connection state determination unit 36 determines whether communication is established between the client terminal 12 and the imaging device 14. The application state determination unit 38 determines whether the application for the imaging device 14 is in an active state (displayed on the top) or not. The electronic device function utilization unit 40 performs a process of using the function of the imaging device 14.

Processing

Hereinafter, the processing of the information processing system 1 according to the present embodiment is described. In order to facilitate the understanding of the processing of the information processing system 1 according to the present embodiment, firmware updating according to the present embodiment is described after firmware updating performed according to the conventional method.

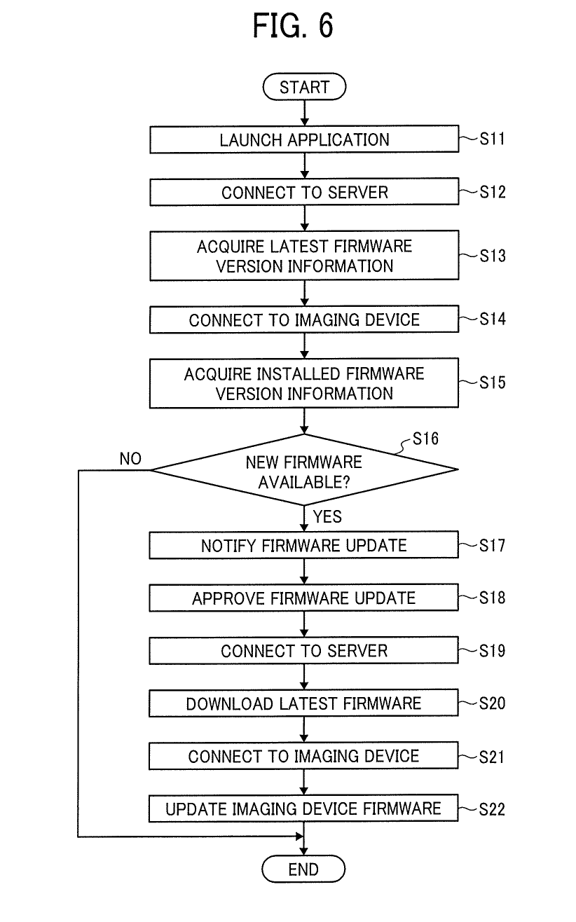

FIG. 6 is a flowchart of an example of a process in which the client terminal 12 updates the firmware installed in the imaging device 14 according to the conventional method.

In step S11, the client terminal 12 launches the application for the imaging device 14, for example, by the user operation. In step S12, the communication processing unit 20 connects to the server 10 in order to acquire information such as notification to the imaging device 14.

In step S13, the latest firmware version information acquisition unit 28 of the client terminal 12 acquires the version information of the latest firmware available on the server 10. In step S14, the installed firmware version information acquisition unit 24 of the client terminal 12 connects to the imaging device 14. In step S15, the installed firmware version information acquisition unit 24 of the client terminal 12 acquires the version information of the firmware installed in the imaging device 14.

In step S16, the firmware update determination unit 30 of the client terminal 12 compares the version information of the latest firmware acquired in step S13 with the version information of the installed firmware acquired in step S15 and determines whether the latest firmware to update the installed firmware is available on the server 10.

When the latest firmware capable of updating the installed firmware exists on the server 10 (S16: Yes), in step S17, the firmware update notification unit 32 notifies the user by displaying on the display that the firmware installed in the imaging device 14 can be updated.

When the user approves the updating of the installed firmware in step S18, the firmware update control unit 34 connects to the server 10 in step S19. In step S20, the firmware update control unit 34 downloads the latest firmware. Upon completion of the download of the latest firmware, the firmware update control unit 34 connects to the imaging device 14 again in step S21. In step S22, the firmware update control unit 34 transfers and installs the latest firmware in the imaging device 14 (executes updating of the installed firmware).

In the firmware updating illustrated in FIG. 6, there is a possibility of the firmware update notification in step S17 hindering the user operation on the imaging device 14. For example, in many cases, the reason for the user to connect the client terminal 12 to the imaging device 14 in step S14 is not to update the installed firmware, but to use the functions of the imaging device 14.

Therefore, if firmware update notification is issued immediately after the client terminal 12 is connected to the imaging device 14 in step S14, user operation such as capturing the image by the imaging device 14 or synchronizing the image data stored in the imaging device 14 may be inhibited.

Therefore, in the firmware updating according to the present embodiment, by providing the firmware update notification while the application for the imaging device 14 is not using the function of the imaging device 14, or by notifying the firmware update by a method not obstructing user operation such as the icon, a badge, the toast pop-up notification, or the like, the inhibition of user operation on the imaging device 14 is avoided. In the firmware updating according to the present embodiment, the client terminal 12 or the application for the imaging device 14 determines that the application for the imaging device 14 is not using the function of the imaging device 14, when the application for the imaging device 14 is being launched, when the client terminal 12 is disconnected from the imaging device 14, when transitioning to a screen that does not require communication with the imaging device 14, or when the application for the imaging device 14 is not active. The screens that do not require communication with the imaging device 14 are the screens other than the image capturing screen and the screen to view the image in the imaging device 14, such as the screen to view the image in the client terminal 12 and the application setting screen. Further, the application for the imaging device 14 is not active when the imaging device 14 is not being operated using the application for the imaging device 14. For example, when the user is using the application for the imaging device 14 to perform parameter setting, environment setting, confirmation of help information, or confirmation of the captured image, the application for the imaging device 14 is not active.

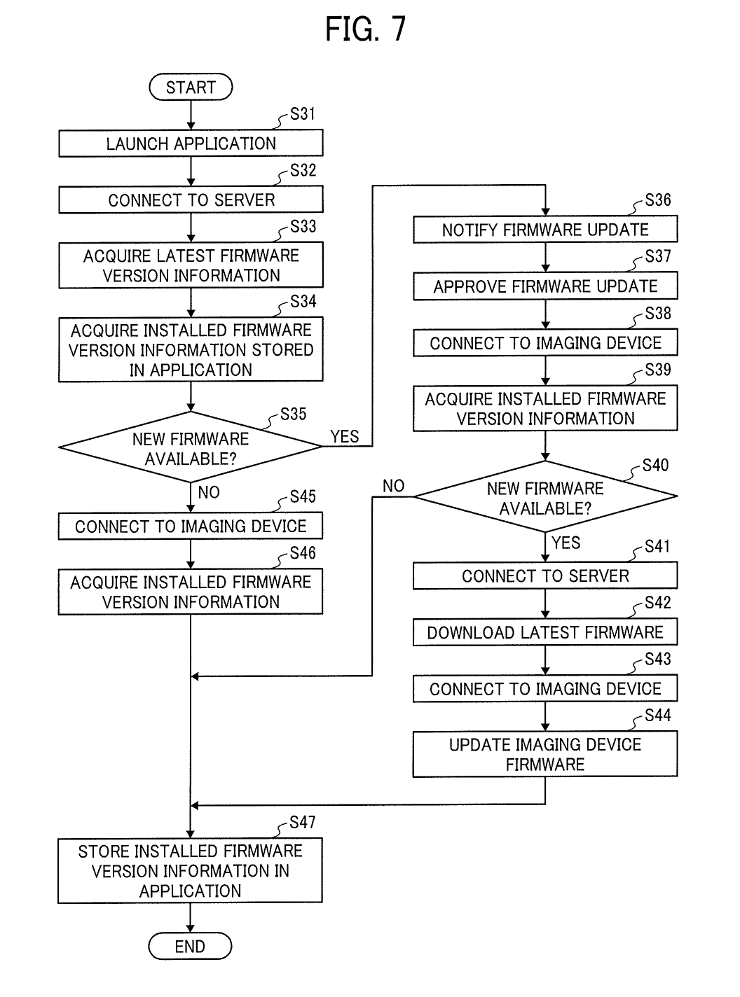

FIG. 7 is a flowchart of first embodiment of the firmware updating by the client terminal 12 to update the firmware installed in the imaging device 14. In the firmware updating of FIG. 7, the version information of the installed firmware acquired from the imaging device 14 when connected to the imaging device 14 the previous time is stored in the installed firmware version information storage unit 26 in step S47.

In step S31, the client terminal 12 launches the application for the imaging device 14, for example, by the user operation. In step S32, the communication processing unit 20 connects to the server 10 in order to acquire information such as notification to the imaging device 14.

In step S33, the latest firmware version information acquisition unit 28 implemented by the application for the imaging device 14 of the client terminal 12 acquires the version information of the latest firmware available on the server 10. In step S34, the firmware update determination unit 30 reads the version information of the firmware installed in the imaging device 14 from the installed firmware version information storage unit 26.

In step S35, the firmware update determination unit 30 compares the version information of the latest firmware acquired in step S33 with the version information of the installed firmware read in step S34 and determines whether the latest firmware capable of updating the installed firmware is available on the server 10.

When the latest firmware capable of updating the installed firmware is available on the server 10 (S35: Yes), the firmware update notification unit 32 of the client terminal 12 displays a message that the firmware installed in the imaging device 14 can be updated in step S36.

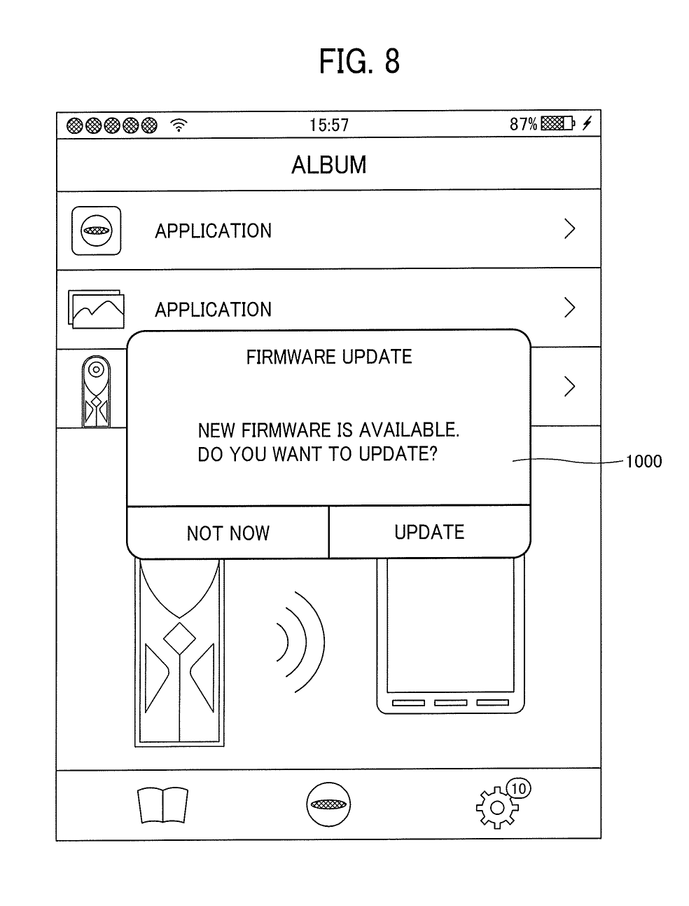

For example, the firmware update notification unit 32 of the client terminal 12 provides notice that the firmware installed in the imaging device 14 can be updated by displaying the update confirmation pop-up 1000 as illustrated in FIG. 8.

FIG. 8 is a conceptual drawing illustrating an example of the update confirmation pop-up. The update confirmation pop-up 1000 allows the user to select either “update” or “not now” for the latest firmware. When “not now” is selected from the update confirmation pop-up 1000 in FIG. 8, the updating of the installed firmware is terminated.

When “update” is selected from the update confirmation pop-up 1000 in FIG. 8, in step S37 the firmware update notification unit 32 of the client terminal 12 determines that the user has approved the update of the installed firmware.

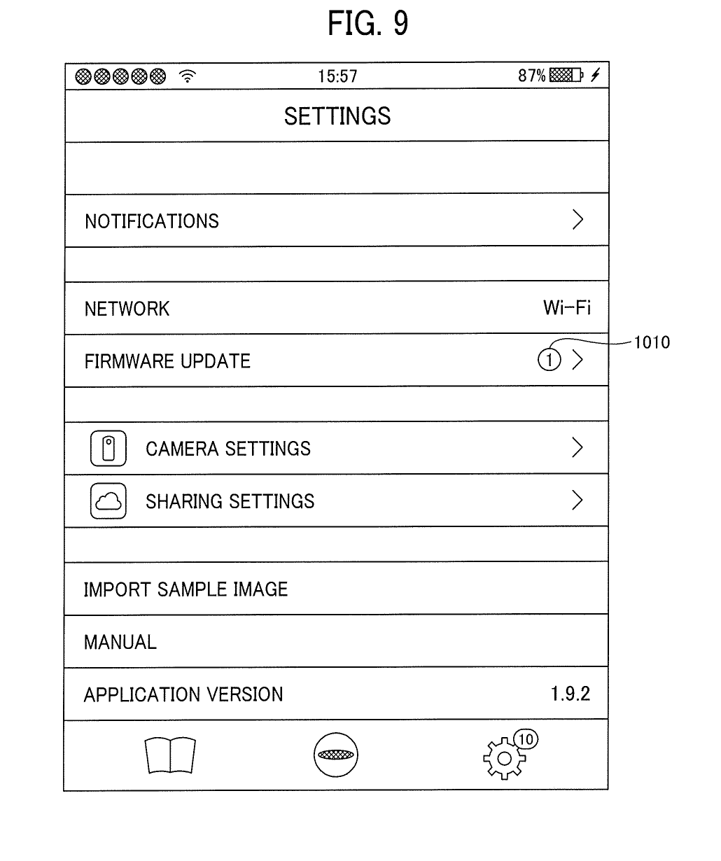

Further, the firmware update notification unit 32 of the client terminal 12 may notify that the firmware installed in the imaging device 14 can be updated by displaying, for example, the icon 1010 in the settings screen as illustrated in FIG. 9. FIG. 9 is a conceptual drawing illustrating an example of the settings screen for notifying by the icon that the installed firmware can be updated. The firmware update notification unit 32 provides notice that the firmware installed in the imaging device 14 can be updated by displaying the icon 1010 in the item field of “firmware update” in the settings screen as illustrated as an example in FIG. 9.

When the user approves to update the installed firmware in step S37, the installed firmware version information acquisition unit 24 of the client terminal 12 connects to the imaging device 14 in step S38. In step S39, the installed firmware version information acquisition unit 24 acquires the version information of the firmware installed in the imaging device 14.

In step S40, the firmware update determination unit 30 compares the version information of the latest firmware acquired in step S39 with the version information of the installed firmware read out in step S34 and determines whether the latest firmware capable of updating the installed firmware is available on the server 10.

When the firmware update determination unit 30 determines that the latest firmware capable of updating the installed firmware is available on the server 10 (S40: Yes), the firmware update control unit 34 connects to the server 10 in step S41. In step S42, the firmware update control unit 34 downloads the latest firmware. Upon completion of downloading the latest firmware, the firmware update control unit 34 connects to the imaging device 14 again in step S43.

In step S44, the firmware update control unit 34 updates the installed firmware by transferring and installing the latest firmware in the imaging device 14.

In step S35, when the firmware update determination unit 30 determines that the latest firmware capable of updating the installed firmware is not available on the server 10 (S35: No), the installed firmware version information acquisition unit 24 of the client terminal 12 connects to the imaging device in step S45. In step S46, the installed firmware version information acquisition unit 24 acquires the version information of the firmware installed in the imaging device 14.

In step S47, the installed firmware version information acquisition unit 24 stores the version information of the firmware installed in the imaging device 14 and terminates the firmware updating illustrated in FIG. 7.

In the firmware updating illustrated in FIG. 7, the application for the imaging device 14 stores the version information of the firmware installed in the imaging device 14 when communication was established between the client terminal 12 and the imaging device 14. By using the installed firmware version information stored in step S47, it is possible to notify the user that the installed firmware can be updated, after launching the application and before connecting to the imaging device 14.

Note that in the firmware updating illustrated in FIG. 7, the firmware installed in the imaging device 14 may be updated by a PC other than the client terminal 12. Therefore, the firmware updating in FIG. 7 can prevent unnecessary downloading of the latest firmware by confirming whether the installed firmware can be updated by the processing of steps S38 to S40. When the latest firmware version is not so large compared to the installed firmware version, such as in the case of a differential update, steps S38 to S40 may be omitted.

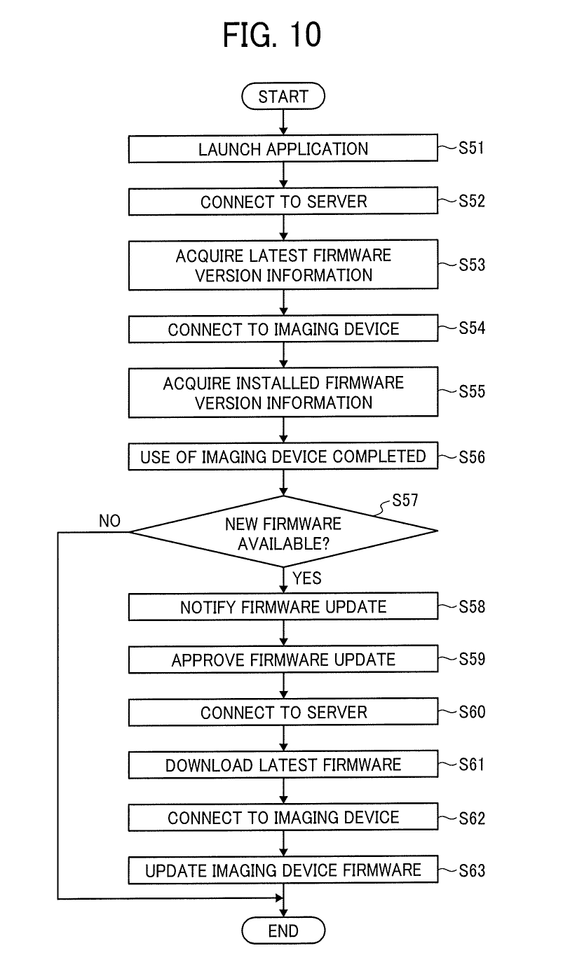

FIG. 10 is a flowchart illustrating a second embodiment of the firmware updating by the client terminal 12 to update the firmware installed in the imaging device 14. In the firmware updating illustrated in FIG. 10, the firmware update notification is issued after the application for the imaging device 14 completed the use of the function of the imaging device 14. Since the processing in steps S51 through S53 is similar to the processing in steps S31 through S33 in FIG. 7, description thereof is omitted. In step S54, the user connects the application for the imaging device 14 installed on the client terminal 12 to the imaging device 14.

In step S55, the installed firmware version information acquisition unit 24 of the client terminal 12 acquires the version information of the firmware installed in the imaging device 14. In step S56, the firmware update determination unit 30 of the client terminal 12 waits until the usage of the imaging device 14 by the application for the imaging device 14 is completed.

The firmware update determination unit 30 determines that the application for the imaging device 14 completed the use of the function of the imaging device 14, for example, when the client terminal 12 and the imaging device 14 are disconnected, or when the application for the imaging device 14 became inactive.

When the firmware update determination unit 30 of the client terminal 12 determines that the application for the imaging device 14 completed the use of the imaging device 14, the process proceeds to step S57. The firmware update determination unit 30 compares the version information of the latest firmware acquired in step S53 with the version information of the installed firmware acquired in step S55 and determines whether the latest firmware capable of updating the installed firmware is available on the server 10.

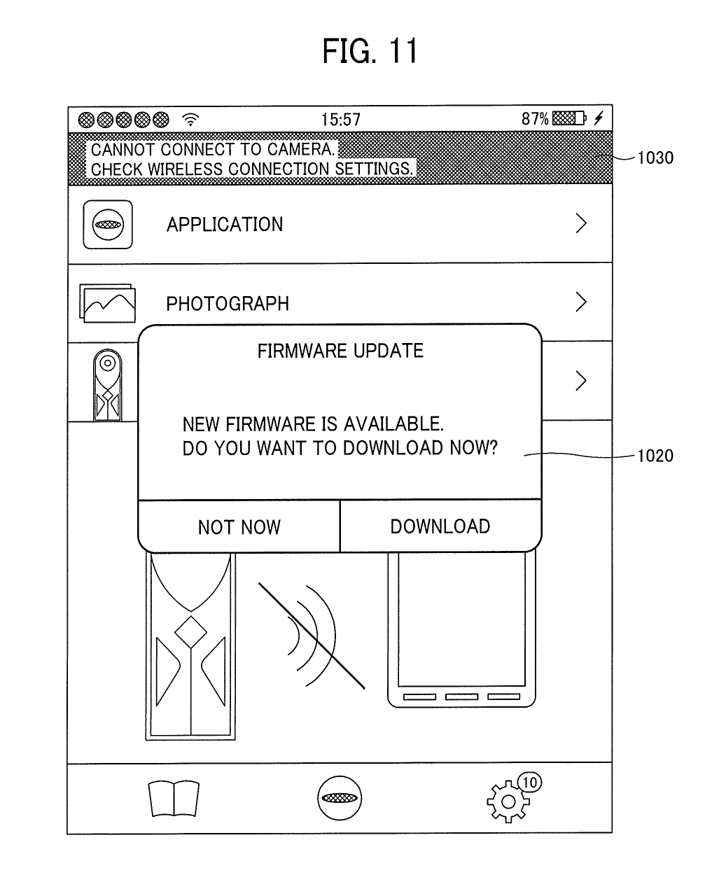

When the latest firmware capable of updating the installed firmware is available on the server 10 (S57: Yes), in step S58, the firmware update notification unit 32 displays the notification to the user that the firmware installed in the imaging device 14 can be updated. For example, by displaying the update confirmation pop-up 1020 illustrated in FIG. 11, the firmware update notification unit 32 provides notice that the firmware installed in the imaging device 14 can be updated.

FIG. 11 illustrates an example of the update confirmation pop-up 1020 displayed when the imaging device 14 is disconnected. When the imaging device 14 is disconnected while the screen requiring connection to the imaging device 14 is being displayed, the firmware update notification unit 32 displays a message 1030 indicating that the imaging device 14 is disconnected. The update confirmation pop-up 1020 of FIG. 11 is displayed, for example, several seconds after the message 1030 is displayed or immediately after the message 1030 disappears.

The connection state determination unit 36 of the client terminal 12 determines whether communication is established between the client terminal 12 and the imaging device 14. After the connection state determination unit 36 is connected to the imaging device 14, the connection state determination unit 36 may check the connection always or when performing an operation requiring communication with the imaging device 14.

In addition, when firmware update notification is performed when the application for the imaging device 14 is active, the firmware update notification unit 32 refers to the determination by the application state determination unit 38 as to whether the application for the imaging device 14 is in the active state (displayed on the top). When the application state determination unit 38 determines that the application for the imaging device 14 is no longer active, the firmware update notification unit 32 notifies the user of the firmware update by a dialog display, the badge or the like. The badge is an additional item of information displayed on the icon of the application. Further, the badge may be some additional information displayed in the item column of the application or the like.

When the user approves to update the installed firmware in step S59, the firmware update control unit 34 connects to the server 10 in step S60. In step S61, the firmware update control unit 34 downloads the latest firmware. Upon completion of downloading the latest firmware, the firmware update control unit 34 resumes the connection to the imaging device 14 in step S62.

In step S63, the firmware update control unit 34 transfers and installs the latest firmware in the imaging device 14.

Note that the application state determination unit 38 uses a mechanism prepared by the operating system for detecting whether the application is displayed on the top, a mechanism for calling a specific process when the application transitions from the top to the background, and a mechanism for specifying the screen transition state of the application. By using such mechanisms, the application state determination unit 38 determines whether the application for the imaging device 14 is active (displayed on the top). For example, the mechanism corresponds to a part of a program to be performed under control of the operating system.

In addition, when making the firmware update notification using the badge, the user can confirm the firmware update notification at the timing of displaying the settings screen as illustrated in FIG. 9. Further, the badge may be displayed before or after step S56 in FIG. 10 as long as the user can recognize that the firmware update is possible in step S58.

Further, the firmware update notification using the dialog display is realized by utilizing the determination by the application state determination unit 38 regarding whether the application for the imaging device 14 is active (displayed on the top). In the case of the firmware update notification using the dialog display, in order to display a dialog when the application for the imaging device 14 is no longer active, processing for dialog display is performed, for example, after step S56 in FIG. 10.

Furthermore, according to the present embodiment, the server 10 may issue the firmware update notification of the imaging device 14 by, for example, a push notification to the client terminal 12. In the firmware updating initiated by the push notification from the server 10 to the client terminal 12, the firmware update notification can be made even when the application for the imaging device 14 is not launched. In addition, the server 10 may notify the client terminal 12 when the new firmware is released, thereby making it unnecessary to check the version information of the firmware installed in the imaging device 14.

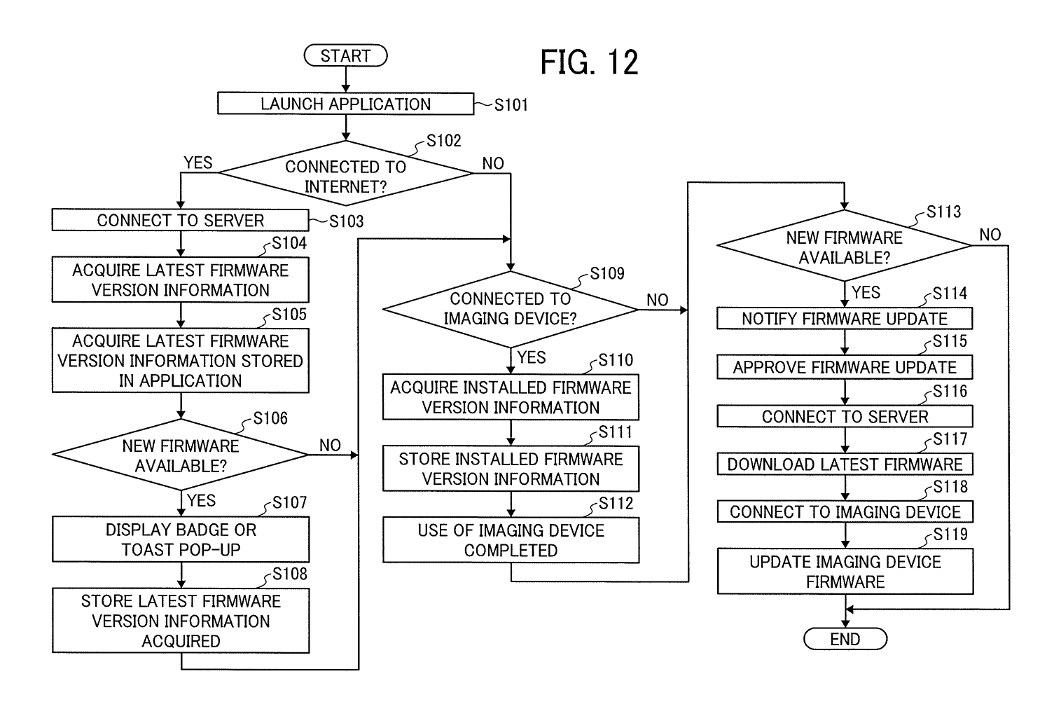

FIG. 12 is a flowchart illustrating a third embodiment of the firmware updating by the client terminal 12 to update the firmware installed in the imaging device 14. In the firmware updating in FIG. 12, the firmware update is notified by the method not disturbing user operation such as the display of the badge or the toast pop-up notification.

In the firmware updating of FIG. 12, the version information of the latest firmware acquired from the server 10 when connected to the server 10 the previous time is stored in the installed firmware version information storage unit 26 in step S108. Also, the version information of the installed firmware acquired from the imaging device 14 when connected to the imaging device 14 is stored in the installed firmware version information storage unit 26 in step S111.

In step S101, the client terminal 12 launches the application for the imaging device 14, for example, by the user operation. In step S102, the client terminal 12 determines whether the connection to the network 16 such as the internet is established. When the communication processing unit 20 of the client terminal 12 is connected to the network 16, the communication processing unit 20 connects to the server 10 in order to acquire information such as notification to the imaging device 14 in step S103.

In step S104, the latest firmware version information acquisition unit 28 of the client terminal 12 acquires the version information of the latest firmware available on the server 10. In step S105, the firmware update determination unit 30 reads the version information of the latest firmware stored in the installed firmware version information storage unit 26.

In step S106, the firmware update determination unit 30 compares the version information of the latest firmware acquired in step S104 with the version information of the firmware read from the installed firmware version information storage unit 26 in step S105.

When the version information of the latest firmware acquired in step S104 is newer than the version information of the firmware read out in step S105 (S106: Yes), the firmware update notification unit 32 of the client terminal 12 causes the process to proceed to step S107. In step S107, the firmware update notification unit 32 notifies the user by the badge, the toast pop-up notification or the like that updating of the firmware installed in the imaging device 14 is possible.

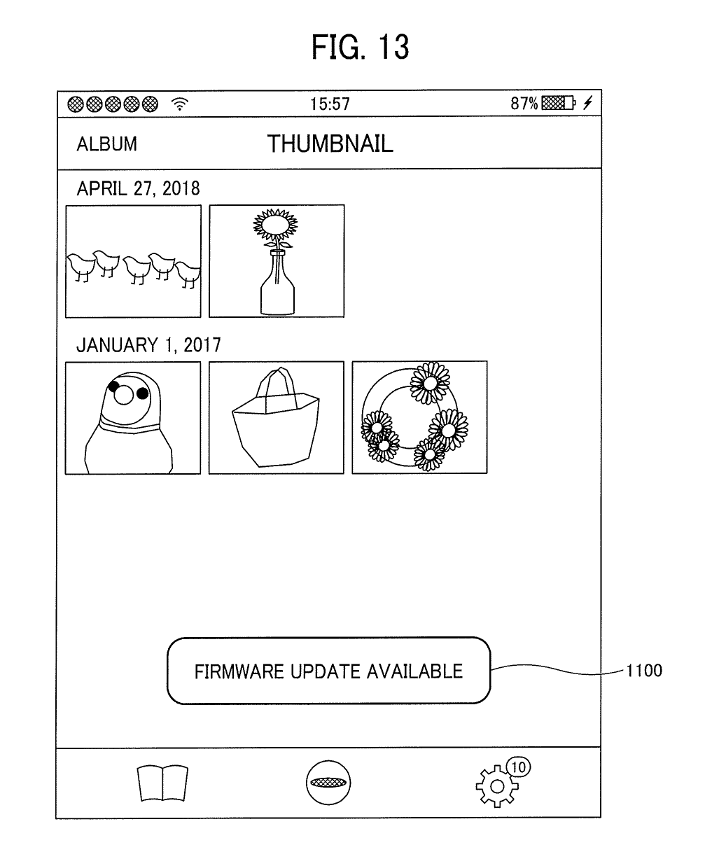

For example, the firmware update notification unit 32 of the client terminal 12 provides notice that updating of the firmware installed in the imaging device 14 is possible by displaying the toast pop-up notification 1100 indicating that “firmware update is available” in FIG. 13. FIG. 13 is a conceptual drawing illustrating an example of the toast pop-up notification that the firmware installed in the imaging device 14 can be updated.

In step S108, the latest firmware version information acquisition unit 28 stores the version information of the latest firmware acquired in step S104 in the installed firmware version information storage unit 26, and the process proceeds to step S109. When the communication processing unit 20 of the client terminal 12 is not connected to the network 16, the process proceeds from step S102 to S109.

In step S109, the client terminal 12 determines whether the connection to the imaging device 14 is established. When the communication processing unit 20 of the client terminal 12 is not connected to the imaging device 14, the process proceeds to step S113. When the communication processing unit 20 of the client terminal 12 is connected to the imaging device 14, the process proceeds to step S110. In step S110, the installed firmware version information acquisition unit 24 acquires the version information of the firmware installed in the imaging device 14.

In step S111, the installed firmware version information acquisition unit 24 stores the version information of the firmware installed in the imaging device 14 in the installed firmware version information storage unit 26. In step S112, the firmware update determination unit 30 of the client terminal 12 waits until the application for the imaging device 14 completes the use of the imaging device 14.

When the application for the imaging device 14 completes the use of the imaging device 14 the firmware update determination unit 30 causes the process to proceed to step S113. In step S113, the firmware update determination unit 30 compares the version information of the latest firmware with the version information of the firmware installed in the imaging device 14. When the latest firmware version is not newer than the installed firmware version (S113: No), the firmware update determination unit 30 terminates the processing as illustrated in the flowchart of FIG. 12.

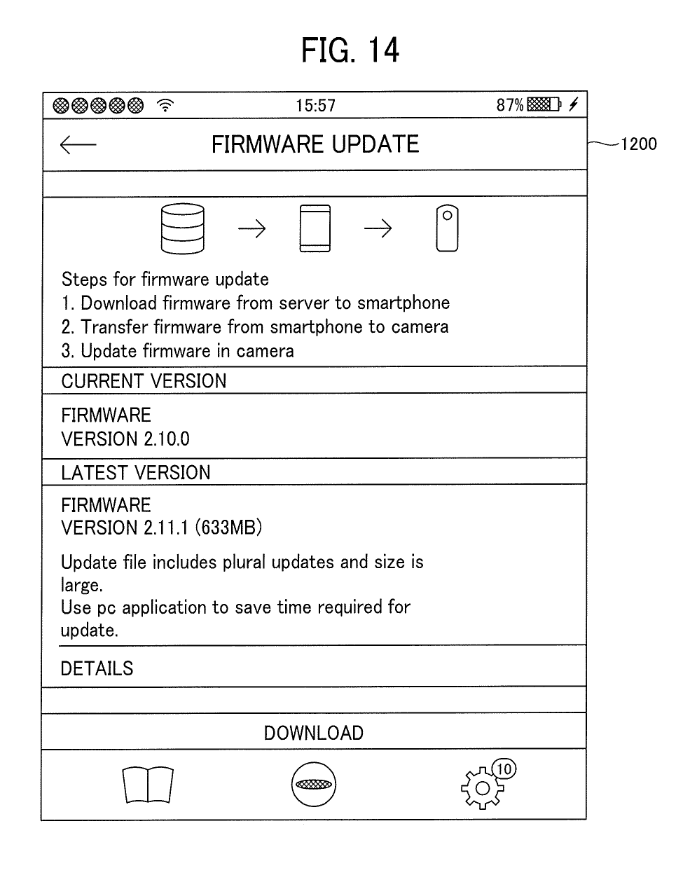

When the latest firmware version is newer than the installed firmware version (S113: Yes), the firmware update notification unit 32 of the client terminal 12 causes the process to proceed to step S114. The firmware update notification unit 32 of the client terminal 12 notifies the user that the firmware installed in the imaging device 14 can be updated by displaying, for example, the update confirmation pop-up 1000 illustrated in FIG. 8 or the firmware update screen 1200 illustrated in FIG. 14.

FIG. 14 is a conceptual drawing illustrating an example of the firmware update screen. The firmware update screen 1200 illustrated in FIG. 14 is an example in which the current version (version information of the installed firmware) and the latest version (version information of the latest firmware) are displayed.

In step S115, when “update” is selected from the update confirmation pop-up 1000 in FIG. 8 or “download” is selected from the firmware update screen 1200 in FIG. 14, the firmware update notification unit 32 of the client terminal 12 determines that the user has approved to update the installed firmware.

When the user approves to update the installed firmware in step S115, the firmware update control unit 34 connects to the server 10 in step S116. In step S117, the firmware update control unit 34 downloads the latest firmware. Upon completion of downloading the latest firmware, the firmware update control unit 34 resumes the connection to the imaging device 14 in step S118.

In step S119, the firmware update control unit 34 transfers and installs the latest firmware in the imaging device 14.

As described above, according to one or more embodiments, the user's operation on the electronic device is not hindered, at least due to updating of the firmware installed on the electronic device.

The above-described embodiments are illustrative and do not limit the present disclosure. Numerous additional modifications and variations are possible in light of the above teachings. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A client terminal comprising:
a communication interface configured to connect to one of an electronic device with firmware installed and a server that provides the firmware at a time; and
circuitry configured to:
acquire version information of the firmware installed on the electronic device;
acquire version information of the latest firmware available on the server;
compare the version of the firmware installed on the electronic device with the version of the latest firmware available on the server;
determine whether the latest firmware to update the firmware installed on the electronic device is available on the server;
provide notice that the latest firmware to update the firmware installed on the electronic device is available, when the latest firmware to update the firmware installed on the electronic device is available on the server; and
update the firmware installed on the electronic device after approval to update the firmware and when the client terminal is not using the electronic device.

2. The client terminal of claim 1, wherein:
the version of the firmware installed on the electronic device is the version of the firmware installed on the electronic device confirmed a previous time the electronic device is connected to the client terminal; and
the circuitry provides the notice that the latest firmware to update the firmware installed on the electronic device is available before the electronic device is connected to the client terminal.

3. The client terminal of claim 1, wherein the circuitry acquires the version information of the firmware installed on the electronic device when communication with the electronic device is established.

4. The client terminal of claim 1, wherein the circuitry acquires the version information of the latest firmware available on the server before communication with the electronic device is established.

5. The client terminal of claim 1, wherein the circuitry provides the notice that the latest firmware to update the firmware installed on the electronic device is available after communication with the electronic device is terminated.

6. The client terminal of claim 1, wherein the circuitry provides notice that the latest firmware to update the firmware installed on the electronic device is available when communication with the electronic device to operate the electronic device is determined not necessary.

7. The client terminal of claim 6, wherein the circuitry provides the notice that the latest firmware to update the firmware installed on the electronic device is available when the client terminal is not using a function of the electronic device.

8. The client terminal of claim 1, wherein the circuitry provides the notice that the latest firmware to update the firmware installed on the electronic device is available by displaying a message or a mark.

9. An information processing system comprising:
the client terminal of claim 1;
a server that provides the firmware for an electronic device; and
the electronic device with the firmware installed.

10. A firmware update notification method comprising:
connecting to one of an electronic device with firmware installed and a server that provides the firmware at a time;
acquiring version information of the firmware installed on the electronic device;
acquiring version information of the latest firmware available on the server;
comparing the version of the firmware installed on the electronic device with the version of the latest firmware available on the server;
determining whether the latest firmware to update the firmware installed on the electronic device is available on the server;
providing notice that the latest firmware to update the firmware installed on the electronic device is available on the server when the latest firmware to update the firmware installed on the electronic device is available on the server; and
updating the firmware installed on the electronic device after approval to update the firmware and when a client terminal is not using the electronic device.

11. The firmware update notification method of claim 10:
wherein the comparing includes comparing the version of the latest firmware available on the server with the version of the firmware installed on the electronic device confirmed the previous time the electronic device is connected to the client terminal; and
wherein the providing includes providing the notice that the latest firmware to update the firmware installed on the electronic device is available before the electronic device is connected to the client terminal.

12. The firmware update notification method of claim 10, wherein the acquiring includes acquiring the version information of the firmware installed on the electronic device when the connection with the electronic device is established.

13. The firmware update notification method of claim 10, wherein the acquiring includes acquiring the version information of the latest firmware available on the server before communication with the electronic device is established.

14. The firmware update notification method of claim 10, wherein the providing includes providing notice that the latest firmware to update the firmware installed on the electronic device is available after communication with the electronic device is terminated.

15. The firmware update notification method of claim 10, wherein the providing includes providing notice that the latest firmware to update the firmware installed on the electronic device is available when communication with the electronic device to operate the electronic device is determined not necessary.

16. The firmware update notification method of claim 15, wherein the providing includes providing notice that the latest firmware to update the firmware installed on the electronic device is available when the client terminal is not using a function of the electronic device.

17. The firmware update notification method of claim 10, wherein the providing includes providing notice that the latest firmware to update the firmware installed on the electronic device is available by displaying a message or a mark.
